(19) United States
(12) Patent Application Publication
(10) Pub. No.: US 2007/0015100 A1
(43) Pub. Date: Jan. 18, 2007

(54) Animal dental care device

(76) Inventor: Lee M. Morris, San Francisco, CA (US)

Correspondence Address: WEST & ASSOCIATES, A PC, 2815 MITCHELL DRIVE, SUITE 209, WALNUT CREEK, CA, 94598, US

(21) Appl. No.: 11/488,882

(22) Filed: Jul. 17, 2006

Related U.S. Application Data
(60) Provisional application No. 60/699,552, filed on Jul. 15, 2005.

(51) Int. Cl. A61D 5/00

(52) U.S. Cl. 433/1

(57) ABSTRACT

An animal dental care device that cleans the teeth as the animal chews on it, wherein the device can include a plurality of protrusions and/or bristles to remove food particles and plaque.

### CLAIM OF PRIORITY

This application claims the benefit of U.S. Provisional Application No. 60/699,552, filed Jul. 15, 2005, the complete contents of which is hereby incorporated herein by reference.

### BACKGROUND

1. Field of the Invention

The present device relates to the field of veterinary care, specifically dental care for animals.

2. Related Art

Dental health is essential to an animal's overall well being. As in humans, the only efficient way to ensure oral health is daily brushing combined with regular professional care. It is a common misconception that dry pet food or “kibble” will act to keep a pet's teeth clean. This is not true, but pet owners of both dogs and cats subscribe to the theory because it gives them some hope that they are doing something proactive for their pets' oral health. Pet owners would be compliant with brushing their pets' teeth if it was easy. However, it is usually a struggle and most people are too busy to spend the time required to train the pet to let them brush their teeth in addition to the time required to do it on a regular basis. After all, most people will not even take the time to floss their teeth on a regular basis.

Several devices have been developed to address this issue. Since many pet owners do not wish to actually brush their pets' teeth, these devices provide a means for the animal to clean his own teeth though a chewing process. These are usually a molded rubber “chew toy” that has grooves, protrusions, or other texture to rub against the teeth and clean them as the animal chews. Some devices are coated with an additional flavoring agent to make the chew toy more palatable for the animal, or a fluoride-based cleaning agent to further clean and polish the teeth. These chew devices are more suited for dogs than cats, because dogs are more likely to display the necessary chewing behavior.

For example the Dental Kong™ device (Kong Co., Golden, Colo.) is an elongated cylindrical rubber chew having a series of ridges and grooves presented circumferentially along its length. As the dog chews it, his teeth move into the grooves, which provide a cleaning surface for both sides of the teeth. The action of the teeth rubbing up against the surfaces presumably removes plaque and food particles.

Although this device provides an enjoyable chew toy and may clean the dog's teeth to some extent, the smooth rubber surfaces do not thoroughly remove enough food particles and plaque to maintain acceptable dental health. Further, dogs often prefer to chew the ends of such devices rendering the “effective surfaces” in the middle of the device ineffective. This devise, is therefore, not very beneficial when chewed in this manner, because only smooth rubber and a piece of cordage rub the tooth surfaces. Moreover, the device only provides a rubbing action on the teeth and does not include a way to enhance the cleaning with toothpaste.

Other devices, such as that described in U.S. Pat. No. 5,467,741 entitled “DOG CHEW TOY FOR CANINE DENTAL CARE AND METHODS FOR MAKING CHEW TOY” to O'Rourke issued on Nov. 21, 1995, consist of a length of knotted rope or cordage that is impregnated with therapeutic or freshening agents. As the dog chews, these agents are released and the fibers and threads of the material serve to clean the dog's teeth and massage the gums. Again, this device can provide some cleaning benefit, but it really cannot provide the needed scrubbing action to thoroughly clean the teeth. Further, once the flavoring or therapeutic agent is used up, the device loses effectiveness and must be replaced.

Another device, described in U.S. Pat. No. 5,944,516 entitled “ANIMAL TOOTH CLEANING DEVICE AND METHOD” to Deshaies issued on Aug. 31, 1999, utilizes brushes on the outer surface of the device. When the dog bites down on the device, a plurality of holes in the outer shell of the device allow it to compress so that the brushes protrude outward more. Although this device appears to provide an improved brushing function, the radially outward orientation of the bristles would not effectively clean the teeth, even with the dog biting down on the device.

What is needed is a device that adequately cleans the animal's teeth, either with or without a replenishable source of flavoring or therapeutic agents.

### BRIEF DESCRIPTION OF THE DRAWINGS

FIG. 1 depicts perspective view of an embodiment of the present device.

FIG. 1a depicts a side view of an embodiment of the present device.

FIG. 2 depicts a side view of an embodiment of the present device, in which the surrounding segments and end members are not fixed.

FIG. 3a depicts an alternative embodiment of surrounding segments.

FIG. 3b depicts an alternative embodiment of surrounding segments.

FIG. 3c depicts an alternative embodiment of surrounding segments.

FIG. 4 depicts an embodiment with alternative end members.

FIG. 5 depicts a side view of an embodiment of the present device with a non-uniform cross-sectional area.

FIG. 5a depicts a side view of a detail of an embodiment of an surrounding member.

FIG. 5b depicts an transverse cross-sectional view of the embodiment shown in FIG. 5.

FIG. 6 depicts another embodiment of the present device with a non-uniform cross-sectional area.

FIG. 7 depicts a side view of an embodiment of the present device with a hollow interior chamber.

FIG. 7a depicts a perspective view of the embodiment shown in FIG. 7.

### DETAILED DESCRIPTION

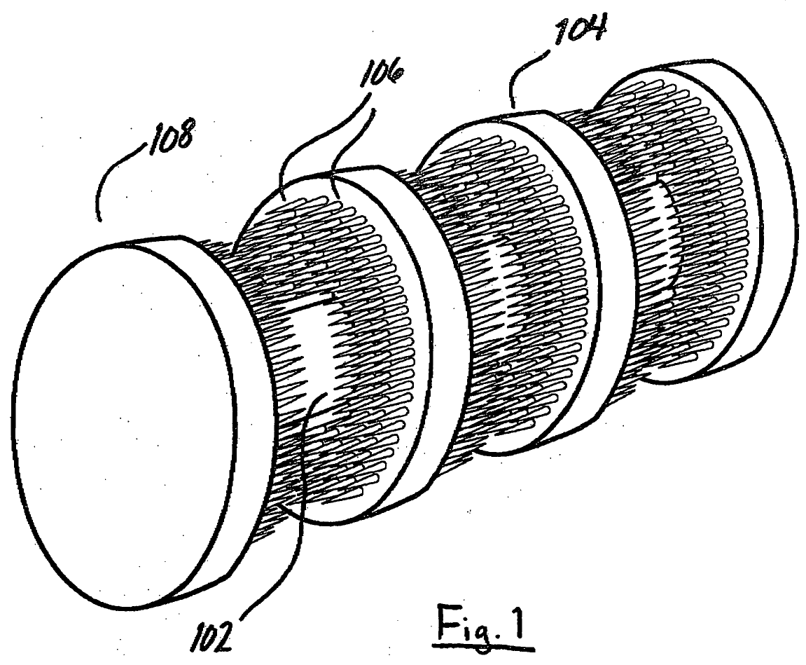

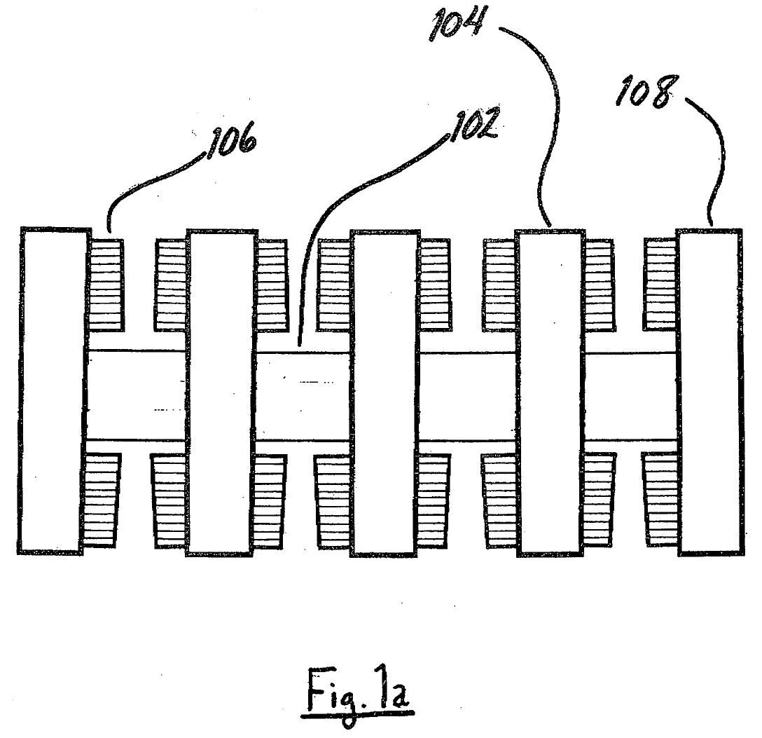

FIG. 1 depicts one embodiment of the present device. A central elongated member 102 can be coupled with a plurality of surrounding segments 104. Said surrounding segments 104 can be oriented such that their central axes coincide with that of the central elongated member 102 and their substantially planar surfaces face that of the adjoining segments 104. A plurality of bristles 106 can be partially inserted into the substantially planar surfaces of the surrounding segments so that they can be substantially perpendicular to the surfaces of the surrounding segments 104 and substantially parallel to the outer surface of the central elongated member 102. In this way, the distal ends of the bristles 106 face each other in the spaces between the surrounding segments 104. End members 108 can be attached to each end of the central elongated member 102.

In FIG. 1, the central elongated member 102 is depicted as a cylinder having a uniform and substantially circular cross-section along its longitudinal axis. However, the central elongated member 102 can have any other polygonal cross-section, such as, but not limited to a quadrilateral, a pentagon, an ellipse, as well as any irregular planar shape. In the embodiment shown in FIG. 1, the central elongated member 102 is also depicted as having a uniform cross-sectional area. However, the cross-sectional area can also vary along the longitudinal axis of the central elongated member 102. The central elongated member 102 can be formed from any known and/or convenient material, such as, but not limited to, polymers or elastomeric polymers, and food-grade polymers. Further, the material used to form the central elongated member 102 can be of any known color and enhanced with any known and/or convenient flavoring or scented agent to make the device more attractive and palatable to an animal. The material can also be dish-washer safe to allow for convenient cleaning of the device.

In embodiment shown in FIG. 1, the plurality of surrounding segments 104 and end members 108 are coupled with the central elongated member 102. The segments 104 and the end members 108 can be integrated with the central elongated member 102, such as, but not limited to, being molded as one piece with the central elongated member 102. Alternatively, the segments 104 and end members 108 can be fabricated separately and then coupled with the central elongated member 102. Said surrounding segments 104 and said end members 108 can be formed from any known and/or convenient material, such as, but not limited to, polymers or elastomeric polymers, and food-grade polymers. Further, the material used to form the surrounding segments 104 and said end members 108 can be of any known color and enhanced with any known and/or convenient flavoring or scented agent to make the device more attractive and palatable to an animal. The material can also be dish-washer safe to allow for convenient cleaning of the device.

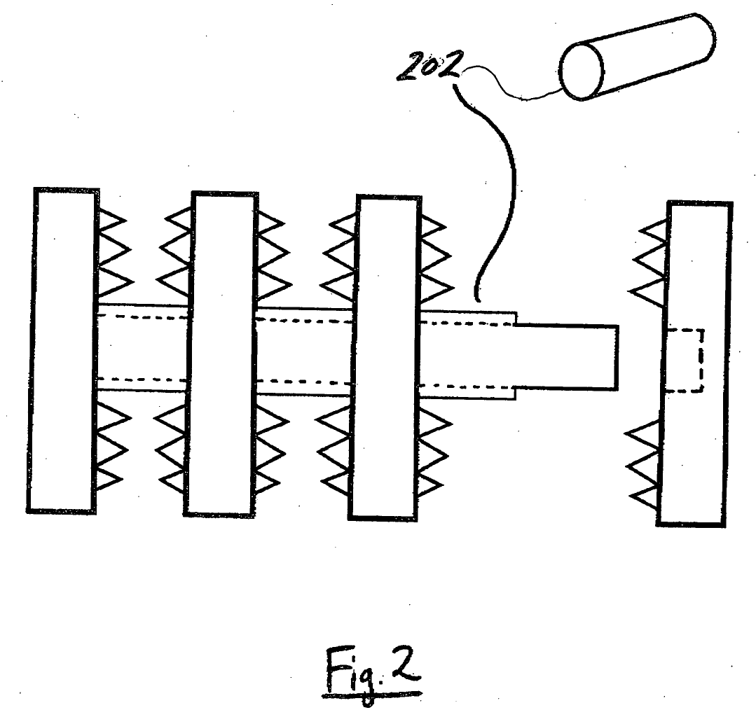

In this embodiment, the surrounding segments 104 are stationary relative to the central elongated member 102. In alternative embodiments shown in FIG. 2, the surrounding segments 104 can be freely translatable about the longitudinal axis of the central elongated member 102. In some embodiments, the end members 108 can be either fixed or removable. In the embodiments having removable end members, the surrounding segments 104 can be removed and replaced if they become worn out or damaged.

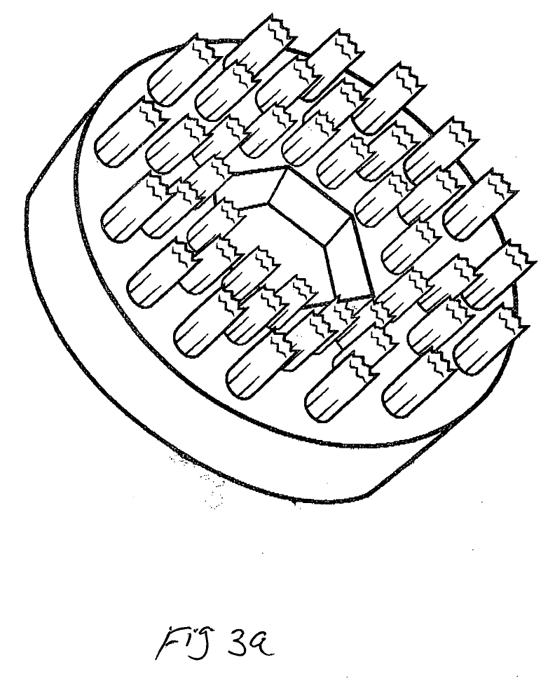

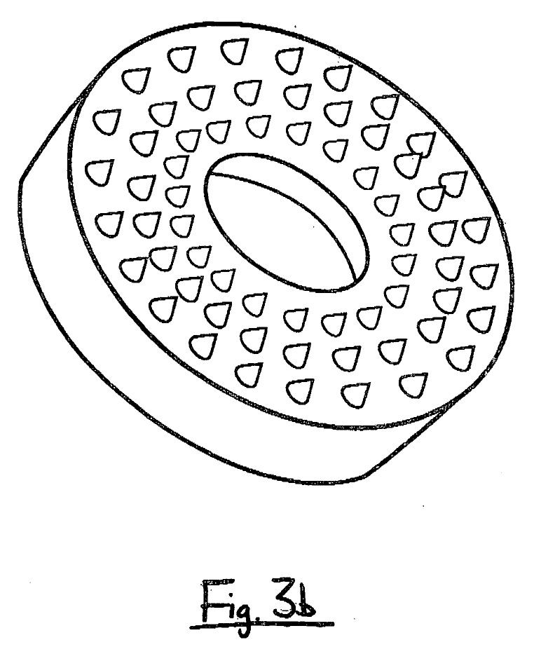

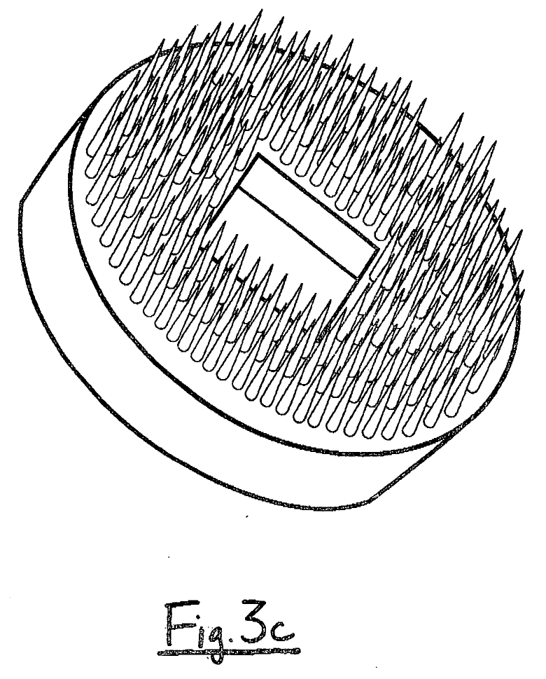

FIG. 3a depicts an embodiment of a surrounding segment 104 that would fit onto some embodiments of the device with the central elongated member 102 having a hexagonal cross-section.

FIG. 3b depicts another embodiment with the surrounding segment 104 that would fit onto embodiments of the device with the central elongated member 102 having a circular cross-section. The embodiment in FIG. 3b also depicts alternate embodiments with pointed nubs 302 instead of bristles protruding from the substantially flat surface of the surrounding segment 104.

FIG. 3c depicts another embodiment of the surrounding segments 104 that would fit onto embodiments of the device with the central elongated member 102 having a quadrilateral cross-section. The embodiment depicted in FIG. 3c can have thicker, pointed bristles 106 protruding from the substantially flat surface of the surrounding segment 104, rather than the bundles in other embodiments. Further, the spacing between the surrounding members 104 can be altered by removing surrounding members 104 and either leaving the space open on the central elongated member 102, or inserting a spacer 202 to maintain a desired spacing between the surrounding segments 104. Said spacers 202 can be formed from any known and/or convenient material, such as, but not limited to, polymers or elastomeric polymers, food-grade polymers. Further, the material used to form the spacers 202 can be of any known color and enhanced with any known and/or convenient flavoring or scented agent to make the device more attractive and palatable to an animal. The material can also be dish-washer safe to allow for convenient cleaning of the device.

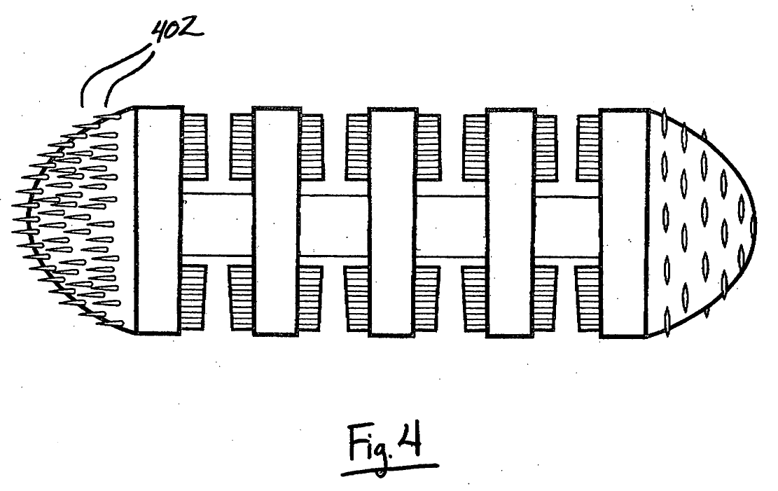

As shown in FIG. 4, in alternative embodiments the end members can have any convenient shape, such as, but not limited to, spherical, hemispherical, conical; pyramidal, or shaped like the end of a bone. The end members 108 can be formed from any known and/or convenient material, such as, but not limited to, polymers or elastomeric polymers, and food-grade polymers. Further, the material used to form the end members 108 can be of any known color and enhanced with any known and/or convenient flavoring or scented agent to make the device more attractive and palatable to an animal. The material can also be dish-washer safe to allow for convenient cleaning of the device. Further, as shown in FIG. 4, in other embodiments, a plurality of bristles 402 can protrude from the end members 108 to provide additional cleaning brushes when the animal chews on the end of the device. Said bristles can be made of any known and/or convenient material, such as, but not limited to nylon filaments, polymers, and food-grade polymers. Further, the bristles can be of any known and/or convenient dimensions and bundled together in any known and/or convenient quantity. In other embodiments, the bristles 106 can be colored, flavored, or treated in any known and/or convenient manner to enhance the appeal and efficacy of the device.

In other embodiments, as discussed above and shown in FIG. 2, the end members 108 can be removably coupled to allow for cleaning of the device or removal or replacement of the surrounding segments 104. In some embodiments, the end members 108 can be attached to the central elongated member by any known and/or convenient mechanism, such as, but not limited to a friction-fit, a threaded screw connection, or a locking connection.

As shown in FIG. 1, and FIG. 4, the plurality of bristles 106 are arranged in bundles and integrated with the surfaces of the surrounding segments 104 that are oriented perpendicularly to the outer surface of the central elongated member 102. In some embodiments, the bristles 106 can be oriented such that they are perpendicular to this surrounding segment surface and parallel to the outer surface of the central elongated member 102. However, the bristles 106 can be oriented at an angle other than ninety degrees relative to said surrounding segment 104 surface. As shown in FIG. 4, the bristles 106 increase in length as they are positioned closer towards the central elongated member 102. However, in alternative embodiments, said bristles 106 can be of uniform length or can vary in length in any uniform, non-uniform, or random pattern.

The bristles 106 can be made of any known and/or convenient material, such as, but not limited to nylon filaments. Further, the bristles can be of any known and/or convenient dimensions and bundled together in any known and/or convenient quantity. In another embodiment, the bristles 106 can be flavored or treated in any known and/or convenient manner to enhance the appeal and efficacy of the device.

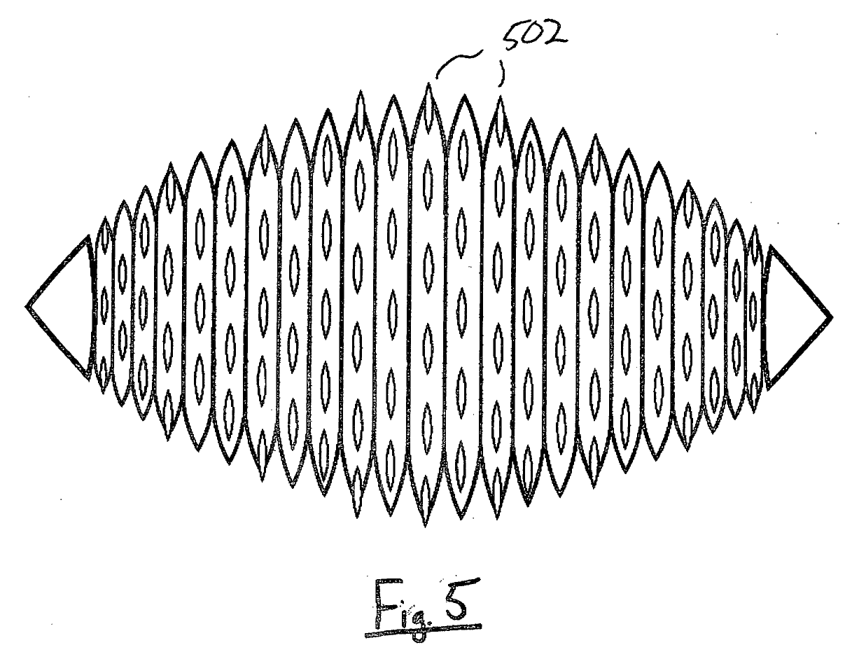

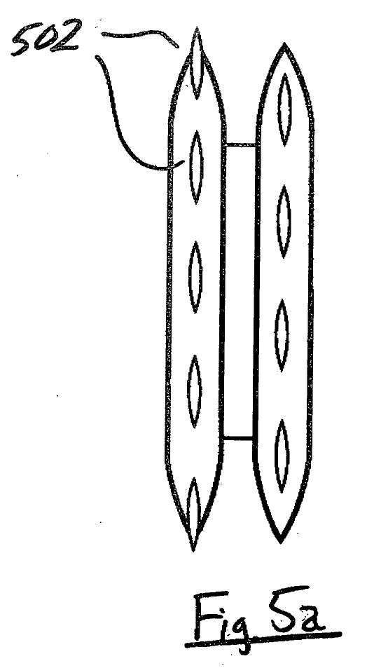

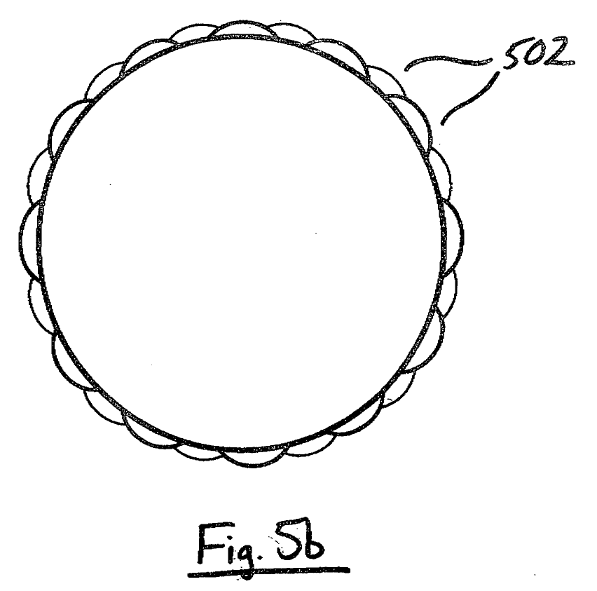

FIG. 5 shows an alternate embodiment of the device, wherein the cross-sectional area of the central elongated member 102 is at a maximum substantially at the longitudinal midline and then decreases towards each end, forming a “double-taper” or “football” shape. In some embodiments, the surrounding segments 104 have a pointed outside edge; they are also depicted as adjoining without any space in between. However, they can also be spaced apart, as depicted in FIG. 5a. As shown in FIG. 5, in some embodiments, along the midline of the thickness of the surrounding segment 104, a plurality of protrusions 502 can extend radially from the longitudinal axis of the central elongated member 102.

FIG. 5b depicts an embodiment, wherein said protrusions 502 can be semicircular. However, in alternate embodiments, the protrusions 502 can have any known and/or convenient geometry and can be spaced along the outer circumference of the surrounding segment in any known and/or convenient manner. In some alternative embodiments, bristles can also be integrated with the surfaces of the surrounding segments 104.

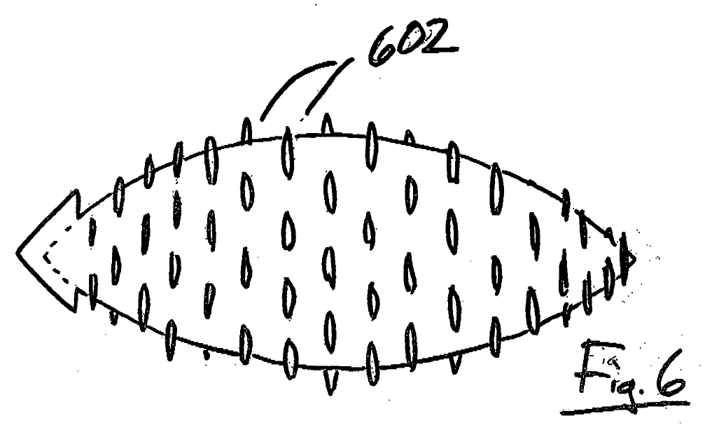

FIG. 6 depicts an alternate embodiment of the present device, in which the surrounding segments 104 can be permanently affixed to the central elongated member 102 and are not continuous circumferentially, but are broken into radial segments 602 protruding substantially perpendicularly from the surface of the central elongated member 102. However, in alternative embodiments, the radial segments can protrude at any other known and/or convenient angle relative to the surface of the central elongated member 102.

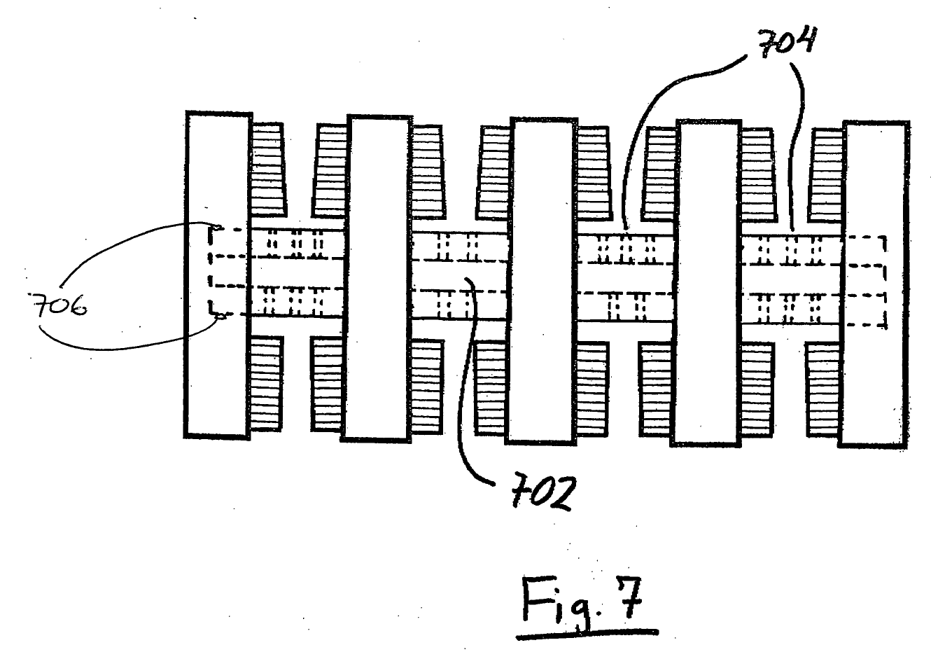

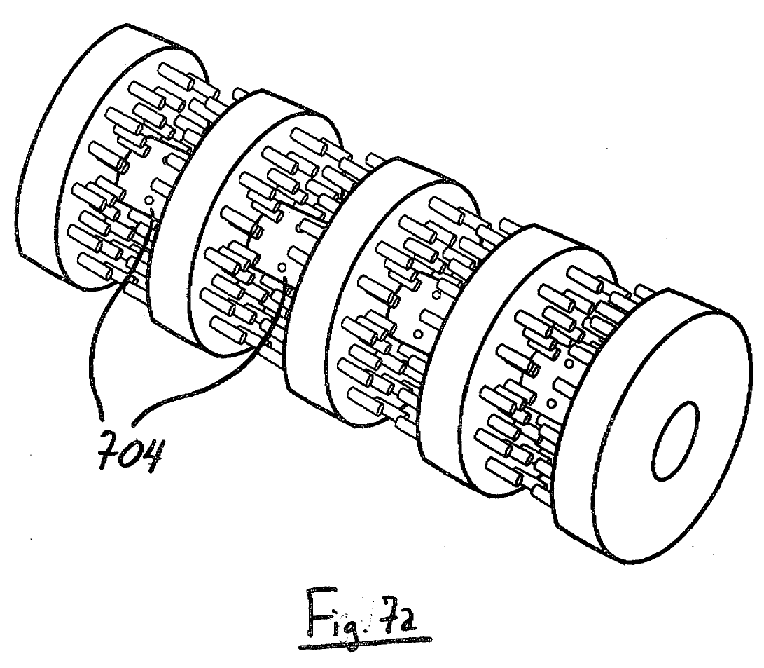

FIG. 7 depicts an alternate embodiment of the present device, wherein an interior hollow chamber 702 runs substantially symmetrically along the longitudinal axis of said central elongated member 102. At least one terminal opening of this hollow chamber 702 can coincide with an end of said central elongated member 102. In the embodiment shown in FIG. 7, a plurality of holes 704 can be made through the exterior surface of said central elongated member 102 in the regions between said surrounding segments 104. Said holes 704 lead to the interior hollow chamber 702 to allow at least a portion of the contents of the interior hollow chamber 702 to pass through the holes 704. The contents of the interior hollow chamber 702 can include, but are not limited to, any known and/or convenient therapeutic or flavoring agent.

In the embodiment shown in FIG. 7, the end members 108 can be removable to allow a therapeutic or flavoring agent to be inserted into the interior chamber. As discussed above, in this embodiment, the end members 108 can be connected by any known and/or convenient mechanism, such as, but not limited to a friction-fit, a threaded screw connection, or a locking connection. Further, there can be security clips 706 attaching the end members 108 to the central elongated member 102 of the device so that they cannot come free and be swallowed by the animal.

In operation, as the animal chews on the embodiment of the device shown in FIG. 1, the animal's teeth enter the regions along the central elongated member 102 between the surrounding segments 104. While chewing, the bristles 106, which can be treated with a therapeutic or flavoring agent, brush away bits of food and plaque that have accumulated on the animal's teeth. In some embodiments with the solid central elongated member 102, a therapeutic or flavoring agent can be applied to the surface of the device to make it more attractive to the animal and to enhance the efficacy of the device.

In the embodiment shown in FIG. 2, as the animal chews, the animal's teeth enter the regions along the central elongated member 102 between the surrounding segments 104, where they are cleaned by the bristles 106. However, in this embodiment the freely translatable surrounding segments provide more bristle 106 motion and additional cleaning action. As the animal chews, the freely translatable surrounding segments 104 can rotate about the central elongated member 102. The freely translatable surrounding segments 104 can also move laterally along the longitudinal axis of the central elongated member 102. Adding spacers 202 can limit this lateral motion, as well as adjust the spacing between the surrounding segments 104. Removing spacers 202 can allow for freer lateral motion along the longitudinal axis of the central elongated member 102 and decrease the spacing between the surrounding segments. In embodiments with removable end members 108, the surrounding segments 104 can be removed either for cleaning or replacement. If the bristles 106 on the surrounding segments 104 lose their flavor or enhanced cleaning properties, or wear out or before the rest of the device does, or if alternative shapes, colors, or flavors are desired, or for any other reason, a consumer can purchase new surrounding segments, with fresh bristles. In addition, the removable end members 108 could be replaced in the same manner.

In the embodiment shown in FIG. 7, the interior chamber 702 can hold a therapeutic agent, flavoring agent, scented agent, treat, or any combination thereof. By removing one or both end members 108, a user can fill the interior chamber 702 with the agent and then re-attach the end members 108 to hold the agent inside the central elongated member 102. When an animal bites down on the device, the bite pressure squeezes down on the central elongated member 102, releasing at least a portion of the contents of the chamber 702. The contents of the chamber 702 can then rest on the outer surface of the device and or the surrounding segments 104. As the animal chews, interior and exterior portions of the animal's teeth can be in contact with the bristles 106, which, with their substantially perpendicular orientation to the animal's teeth in this embodiment, serve to brush the animal's teeth not unlike that of a human toothbrush. After the animal finishes with it, the device can be cleaned out and then refilled for the next use.

Having end members 108 with additional bristles 106 protruding from their surfaces provides additional cleaning efficacy. Often, animals could desire to chew on the end of a toy, or bone, in the case of a dog. In this situation, the additional bristles 106 can help to ensure that the animal gets the maximum cleaning benefit from the device. In another embodiment relating to the embodiments with the hollow interior chamber 702, the end members 108 could also have holes 704 to allow the therapeutic agent, flavoring agent, or any combination thereof to more effectively get to the surfaces of the end members 108.

In embodiments with removable end members 108, a user could change the ends not only due to wear, but to utilize the most effective shape for the animal. For example, different breeds of dogs have different shaped jaws that can be better cleaned by differently shaped end members 108.

Another embodiment could include a noise-making device, such as a squeaker, embedded in the central elongated member 102, the surrounding segments 104, or the end members 108 to further reward the dog for chewing on the device.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A device for cleaning an animal's teeth, comprising:
a central elongated member having two ends and an outer surface;
a plurality of surrounding segments having a transverse cross-sectional area that is larger than that the transverse cross-sectional area of said central elongated member, wherein said segments are spaced out along the length of the central elongated member;
a plurality of bristles, wherein said bristles are coupled with the surfaces of said surrounding segments;
end members, wherein said end members are coupled with the ends of said central elongated member.

2. The device of claim 1, wherein said bristles are of uniform length.

3. The device of claim 1, wherein said bristles are of varying lengths.

4. The device of claim 1, wherein said bristles are oriented substantially perpendicular to the surfaces of said surrounding segments.

5. The device of claim 1, wherein said bristles are treated with a flavoring agent.

6. The device of claim 1, wherein said end members are selectively coupled with the ends of said elongated member.

7. The device of claim 1, wherein the cross section of said central elongated member is uniform along the longitudinal axis of said central elongated member.

8. The device of claim 7, wherein the cross section of said central elongated member is selected from the group consisting of: substantially circular and polygonal.

9. The device of claim 1, wherein the cross section of said central elongated member varies along the longitudinal axis of said central elongated member.

10. The device of claim 9, wherein the cross section of said central elongated member is selected from the group consisting of: substantially circular and polygonal.

11. The device of claim 1, wherein said plurality of segments are integrated with the central elongated member

12. The device of claim 1, wherein said plurality of segments and said end members are removably attached to said central elongated member.

13. The device of claim 12, wherein said segments and end members are replaceable.

14. The device of claim 1, wherein the geometry of said end members is selected from the group consisting of: substantially hemispherical, substantially spherical, substantially conical, substantially pyramidical, and substantially elliptical.

15. The device of claim 14, wherein said end members further comprise a plurality of bristles affixed substantially perpendicular to the surfaces of said end members.

16. The device of claim 1, further comprising:
an interior hollow chamber running substantially symmetrically along the longitudinal axis of said central elongated member and having at least one terminal opening coinciding with an end of said central elongated member;
a plurality of holes running from the outer surface of said central elongated member to the interior hollow chamber, said holes being located in the regions of the central elongated member between the surrounding segments;
wherein at least one of said end members is removably attached to the ends of said central elongated member.

17. The device of claim 16, wherein said bristles are of uniform length.

18. The device of claim 16, wherein said bristles are of varying lengths.

19. The device of claim 16, wherein said bristles are treated with a flavoring agent.

20. The device of claim 16, wherein the cross section of said central elongated member is uniform along the longitudinal axis of said central elongated member.

21. The device of claim 20, wherein the cross section of said central elongated member is selected from the group consisting of: substantially circular and polygonal.

22. The device of claim 16, wherein the cross section of said central elongated member varies along the longitudinal axis of said central elongated member.

23. The device of claim 22, wherein the cross section of said central elongated member is selected from the group consisting of: substantially circular and polygonal.

24. The device of claim 16, wherein said plurality of segments are integrated with the central elongated member

25. The device of claim 16, wherein said plurality of segments and said end members are removably attached to said central elongated member.

26. The device of claim 25, wherein said segments and said end members are replaceable.

27. The device of claim 16, wherein the geometry of said end members is selected from the group consisting of: substantially hemispherical, substantially spherical, substantially conical, substantially pyramidical, and substantially elliptical.

28. The device of claim 27, wherein said end members further comprise a plurality of bristles affixed substantially perpendicular to the surfaces of said end members.

29. A method for using the device of claim 16, comprising the steps of:
Removing at least one of said end members;
Inserting a tooth cleaning agent into said hollow chamber;
Re-attaching said removed end member or members; and
As the animal chews said device, said cleaning agent exits said hollow chamber via said plurality of holes in said elongated central elongated member and facilitates cleaning of the animal's teeth.
